(19) United States
(12) Patent Application Publication
(10) Pub. No.: US 2006/0093282 A1
(43) Pub. Date: May 4, 2006

(54) Method and apparatus for providing connector keying and identification for unidirectional fiber cables

(76) Inventors: Christian Shepherd, Chaska, MN (US); Todd R. Burkey, Savage, MN (US); Roger Haro, Eden Prairie, MN (US)

Correspondence Address: Crawford Maunu PLLC, Suite 390, 1270 Northland Drive, St. Paul, MN, 55120, US

(21) Appl. No.: 11/108,230

(22) Filed: Apr. 18, 2005

Related U.S. Application Data
(60) Provisional application No. 60/623,378, filed on Oct. 29, 2004.

(51) Int. Cl. G02B 6/36; G02B 6/00

(52) U.S. Cl. 385/90; 385/136; 385/137; 385/88; 385/89; 385/92

(57) ABSTRACT

A method and apparatus for providing connector keying and identification for unidirectional fiber cables are disclosed. Three connector subassemblies are provided, wherein first and second subassemblies are both oriented in alignment to prevent a cable for coupling to receive connections from being plugged into transmit connections and vice versa. A third portion of the connector assembly slides into the second portion and provides a place to put a label identifying the cables destination and source. All portions can be designed for hand assembly and disassembly, allowing dynamic field setup.

### BACKGROUND OF THE INVENTION

1. Field of the Invention

This invention relates in general to fiber optic cable connectors, and more particularly to a method and apparatus for providing connector keying and identification for unidirectional fiber cables.

2. Description of Related Art

The development of fiber optic components and application techniques has led to increasing utilization of fiber optics for communicating signals. In recent years it has become apparent that fiber-optics are steadily replacing copper wire as an appropriate means of communication signal transmission. Telecommunication applications are widespread, ranging from global networks to desktop computers. These involve the transmission of voice, data, or video over distances of less than a meter to hundreds of kilometers, using one of a few standard fiber designs in one of several cable designs.

Fiber optic cable typically includes at least one glass core for optical, high bandwidth transmission of information. Typically, fiber optic cable requires a minimum bending radius (e.g., a one-inch bending radius) to avoid damaging the glass core and to avoid producing a large dB loss in the transmission of information through the cable. Improper handling of fiber optic cable during shipment and installation can damage the cable. Twists or kinks in the cable can cause microscopic cracks, which over time can propagate in the cable and decrease the reliability and longevity of the system and result in costly field repairs and replacements.

Fiber optic connectors of a wide variety of designs have been employed to terminate optical fiber cables and to facilitate connection of the cables to other cables or other optical fiber transmission devices. Fiber optic connectors have traditionally been the biggest concern in using fiber optic systems. While connectors were once unwieldy and difficult to use, connector manufacturers have standardized and simplified connectors greatly. This increasing user-friendliness has contributed to the increase in the use of fiber optic systems; it has also taken the emphasis off the proper care and handling of optical connectors.

A typical fiber optic connector includes a splice, a permanent connection, or a connector, which differs from the splice in its ability to be disconnected and reconnected. Fiber optic connector types are as various as the applications for which they were developed. Different connector types have different characteristics, different advantages and disadvantages, and different performance parameters. But all connectors have the same four basic components.

A fiber is mounted in a long, thin cylinder, the ferrule, which acts as a fiber alignment mechanism. The ferrule is bored through the center at a diameter that is slightly larger than the diameter of the fiber cladding. The end of the fiber is located at the end of the ferrule. Ferrules are typically made of metal or ceramic, but they may also be constructed of plastic. The fiber optic connector also includes a connector body, which is often referred to as the connector housing. The connector body holds the ferrule and is usually constructed of metal or plastic. The connector body includes one or more assembled pieces which hold the fiber in place. The exact configurations of these connector body assemblies vary among connectors. The ferrule extends past the connector body to slip into the coupling device. The cable is attached to the connector body. The cable acts as the point of entry for the fiber. Typically, a strain-relief boot is added over the junction between the cable and the connector body, providing extra strength to the junction.

A fiber optic connector assembly typically includes some form of housing which mates with a complementary mating connector such as an electrical connecting device or an optical fiber transmission device. The connector housing may terminate a plurality of cables which are to be interconnected with the complementary mating connector. For instance, the housing may include a plurality of passages for receiving ferrules terminated to the fiber cores of fiber optic cables or for receiving conductive terminals terminated to the conductors of a plurality of electrical cables.

In today's highly connected and highly compact data centers assuring equipment is cabled up properly is becoming increasingly more difficult. Currently, labels are typically used to identify where and how fiber optic connectors should be installed. For example, labels may be wrapped around the end of the cables to identify where they were to go in the system. However, such labeling system do not ensure continuity in the fiber loop because the connectors may be plugged into either a transmit or receive port.

It can be seen then that there is a need for a method and apparatus for providing connector keying and identification for unidirectional fiber cables.

### SUMMARY OF THE INVENTION

To overcome the limitations in the prior art described above, and to overcome other limitations that will become apparent upon reading and understanding the present specification, the present invention discloses a method and apparatus for providing connector keying and identification for unidirectional fiber cables.

The present invention solves the above-described problems by providing three connector subassemblies, wherein first and second subassemblies are both oriented in alignment to prevent a cable for coupling to receive connections from being plugged into transmit connections and vice versa. A third portion of the connector assembly slides into the second portion and provides a place to put a label identifying the cables destination and source.

A connector assembly in accordance with the principles of an embodiment of the present invention includes a first portion for coupling to a chassis proximate to a fiber optic connector on the chassis and second portion configured for coupling onto the connector of a fiber cable, wherein the first portion and the second portion each include a first and second orientation for indicating an incoming and an outgoing signal respectively, the first and second portions being aligned in one of the first or second orientations depending on whether the cable is for coupling to a receive or transmit connection or in multihost environments a coupling to an in and an out or a host and an expansion connection typically seen in fibre channel drive bays.

In another embodiment of the present invention, a communication system is provided. The communication system includes a first transceiver including at least one transmitter and at least one receiver, a second transceiver including at least one transmitter and at least one receiver, a first fiber optic cable disposed between the first transceiver and the second transceiver for coupling the transmitter of the first transceiver to the receiver of the second transceiver, a second fiber optic cable disposed between the first transceiver and the second transceiver for coupling the receiver of the first transceiver to the transmitter of the second transceiver and a connector assembly coupled to each end of the first and second fiber optic cable, the connector assembly including a first portion for coupling to a chassis for a transceiver proximate to a fiber optic connector on the chassis, second portion configured for coupling onto the connector of a fiber cable, wherein the first portion and the second portion each include a first and second orientation for indicating an incoming and an outgoing signal respectively, the first and second portions being aligned in one of the first or second orientations depending on whether the cable is for coupling to a receiver or transmitter.

In another embodiment of the present invention, another connector assembly is provided. This connector assembly includes first means for coupling to a chassis proximate to a fiber optic connector on the chassis and second means for coupling onto the connector of a fiber cable, wherein the first means and the second means each include a first and second orientation for indicating an incoming and an outgoing signal respectively, the first and second means being aligned in one of the first or second orientations depending on whether the cable is for coupling to a receive or transmit connection.

In another embodiment of the present invention, another communication system is provided. This communication system includes first means for communicating including at least one means for transmitting and one means for receiving, second means for communicating including at least one means for transmitting and one means for receiving, first means, disposed between the first means for communicating and the second means for communicating, for providing a communication conduit between the means for transmitting of the first means for communicating to the means for receiving of the second means for communicating, second means, disposed between the first means for communicating and the second means for communicating, for providing a communication conduit between the means for receiving of the first means for communicating to the means for transmitting of the second means for communicating, means, coupled to each end of the first and second means for providing a communication conduit, for providing a connection interface, the means for providing a connection interface including first means for coupling to a chassis proximate to a communications conduit connector on the chassis and second means for coupling onto the connector of means for providing a communication conduit, wherein the first means for coupling to a chassis and the second means for coupling onto the connector each include a first and second orientation for indicating an incoming and an outgoing signal respectively, the first means for coupling to a chassis and the second means for coupling onto the connector being aligned in one of the first or second orientations depending on whether the means for providing communications conduit is for coupling to means for receiving or means for transmitting.

In another embodiment of the present invention, a method for providing connector keying and identification for unidirectional fiber cables is provided. The method includes providing a first connector subassembly for coupling to a chassis proximate to a fiber optic connector on the chassis, the first connector subassembly including a first and second orientation for indicating an incoming and an outgoing signal respectively, providing a second connector subassembly configured for coupling onto the connector of a fiber cable, the second connector subassembly including a first and second orientation for indicating an incoming and an outgoing signal respectively and aligning the first connector subassembly and the second connector subassembly in one of the first or second orientations depending on whether the cable is for coupling to a receive or transmit connection.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a block diagram of a fiber optic communications system according to an embodiment of the present invention;

FIG. 2 illustrates two versions of optical connectors for use with fiber optic cable;

FIG. 3 illustrates a block diagram showing multiple fiber optic cable connectors being attached to a fiber optics communications system;

FIG. 4 illustrates a connector assembly according to an embodiment of the present invention; and

FIG. 5 illustrates a plurality of connector assemblies coupled to a chassis according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method and apparatus for providing connector keying and identification for unidirectional fiber cables. The connector assembly includes three portions, wherein a first and second portion are both oriented in alignment to prevent cable for coupling to receive connections from being plugged into transmit connections and vice versa. A third portion of the connector assembly slides into the second portion and provides a place to put a label identifying the cables destination and source.

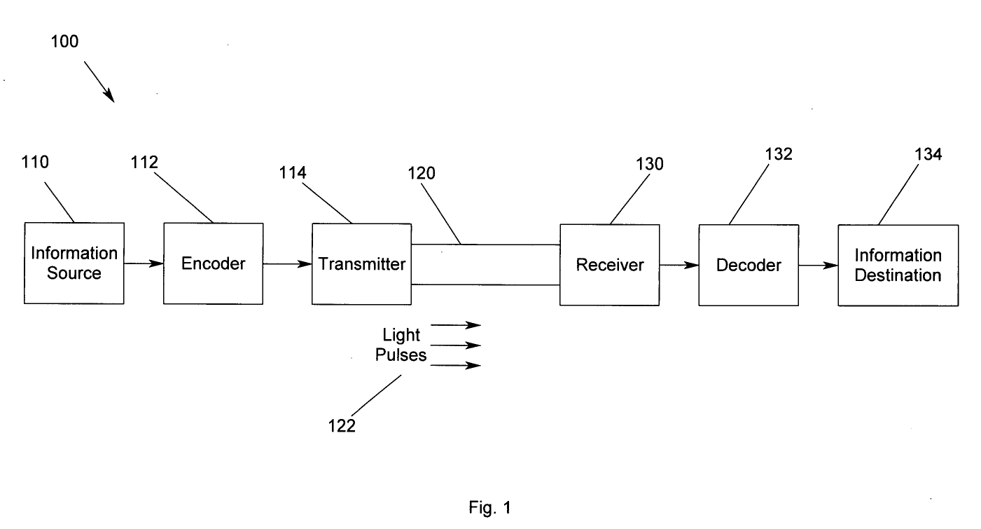

FIG. 1 illustrates a block diagram of a fiber optic communications system 100 according to an embodiment of the present invention. In FIG. 1, information (voice, data, and video) from the source 110 is encoded by an encoder 112 into electrical signals that can drive the transmitter 114. The fiber 120 acts as an optical waveguide for the light pulses 122 as they travel down the optical path toward the receiver 130. At the receiver 130, a detector performs an optical-to-electrical (OE) conversion. The electrical signals are then decoded by decoder 132 and sent to their destination 134.

The transmitter 114 provides a source of the light launched into the fiber-optic cable 120 and modulates the light signal to represent the binary data that it receives from the source 110. A transmitter's physical dimensions must be compatible with the size of the fiber-optic cable 120 being used. The optical source must be able to generate enough optical power so that the desired bit error rate (BER) can be met. The optical source must be easily modulated with an electrical signal and must be capable of high-speed modulation; otherwise, the bandwidth benefits of the fiber-optic cable 120 are lost. The transmitter 114 is typically pulsed at the incoming frequency and performs a transducer electrical-to-optical (EO) conversion. Light-emitting diodes (LEDs) or vertical cavity surface emitting lasers (VCSELs) are usually used to drive multimode systems, whereas laser diodes are used to drive single mode systems.

The receiver 130 senses or detects the light coupled out of the fiber-optic cable 120 and converts the light into an electrical signal. The receiver 130 must also demodulate the light to determine the identity of the binary data that it represents. The receiver performs the OE transducer function. Light detection is carried out by a photodiode that senses light and converts it into an electrical current. However, because the optical signal from the fiber-optic cable 120 and the resulting electrical current have a small amplitude, the photodiode circuitry may be followed by one or more amplification stages. Moreover, filters and equalizers may be used to shape and improve the information-bearing electrical signal. The receiver 130 may also incorporate a number of other functions, such as clock recovery for synchronous signaling, decoding circuitry, and error detection and recovery.

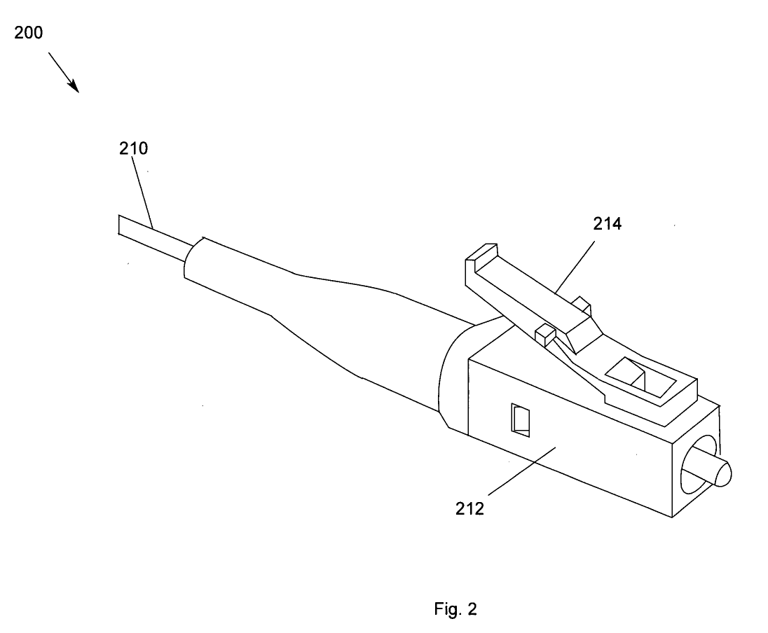

FIG. 2 illustrates an optical connector 200 for use with fiber optic cable. The connector 200 is a mechanical device mounted on the end of a fiber-optic cable 210, light source, receiver, or housing. In FIG. 2, a single LC connector is shown. Dual LC connectors are also available. LC connectors provide for accurate alignment via their ceramic ferrules 212. LC connectors also have a locking tab 214.

Nevertheless, there are many types of optical connectors including FC, MT-RJ, SC and ST connectors. FC connectors offer extremely precise positioning of the fiber-optic cable with respect to the transmitter's optical source emitter and the receiver's optical detector. FC connectors feature a position locatable notch and a threaded receptacle. FC connectors are constructed with a metal housing and are nickel-plated. FC connectors also include ceramic ferrules. MT-RJ connectors are constructed with a plastic housing and provide for accurate alignment via their metal guide pins and plastic ferrules. SC connectors offer low cost, simplicity, and durability. SC connectors provide for accurate alignment via their ceramic ferrules. An SC connector is a push-on, pull-off connector with a locking tab. The ST connector is a keyed bayonet connector and is used for both multimode and single-mode fiber-optic cables. It can be inserted into and removed from a fiber-optic cable both quickly and easily and come in a keyed and spring-loaded model. The type of connector typically depends on the equipment being used and the application.

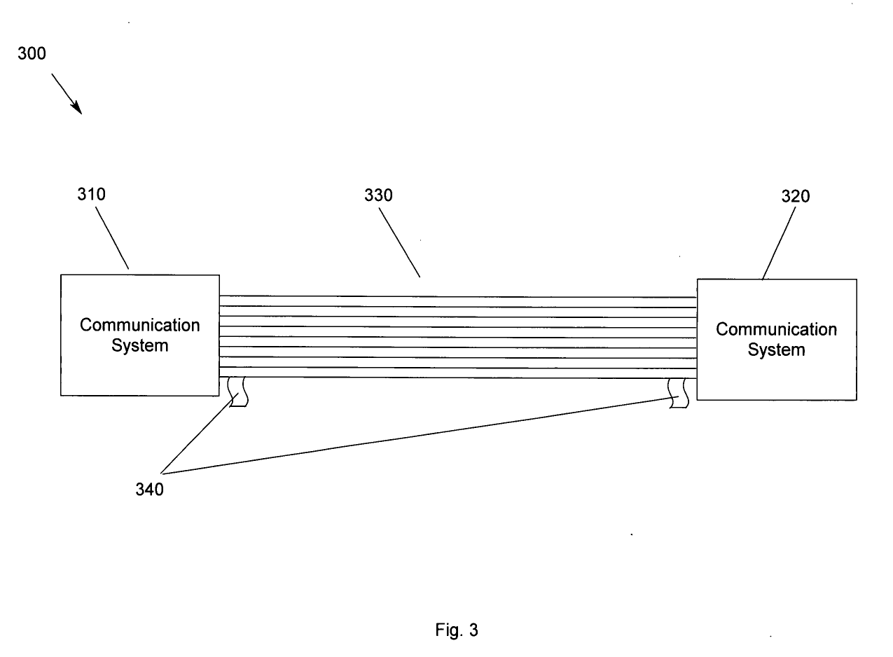

FIG. 3 illustrates a block diagram 300 showing multiple fiber optic cable connectors being attached to a fiber optics communications system. In FIG. 3, two communications systems 310, 320 are coupled via a plurality of fiber optic cables 330. While FIG. 3 shows all of the fiber optic cables 330 coupled between communication systems 310, 320, those skilled in the art will recognize that at least some of the fiber optic cables 330 may be routed to other communication systems (not shown). Nevertheless, each fiber optic cable 330 is a unidirectional fiber cables, which provides either incoming data or out-going data. However, there is no way to visually determine whether a particular cable 330 is connected properly. To overcome this problem, labels 340 are typically used to identify where and how fiber optic connectors should be installed. However, such a labeling system 340 does not ensure continuity in the fiber loop because the connectors may be plugged into either a transmit or receive port.

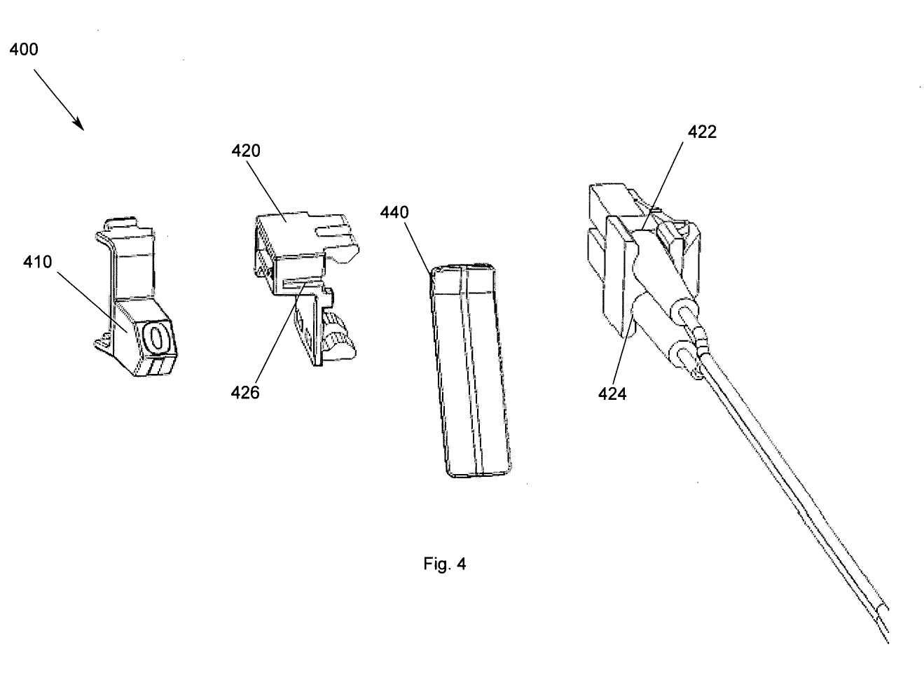

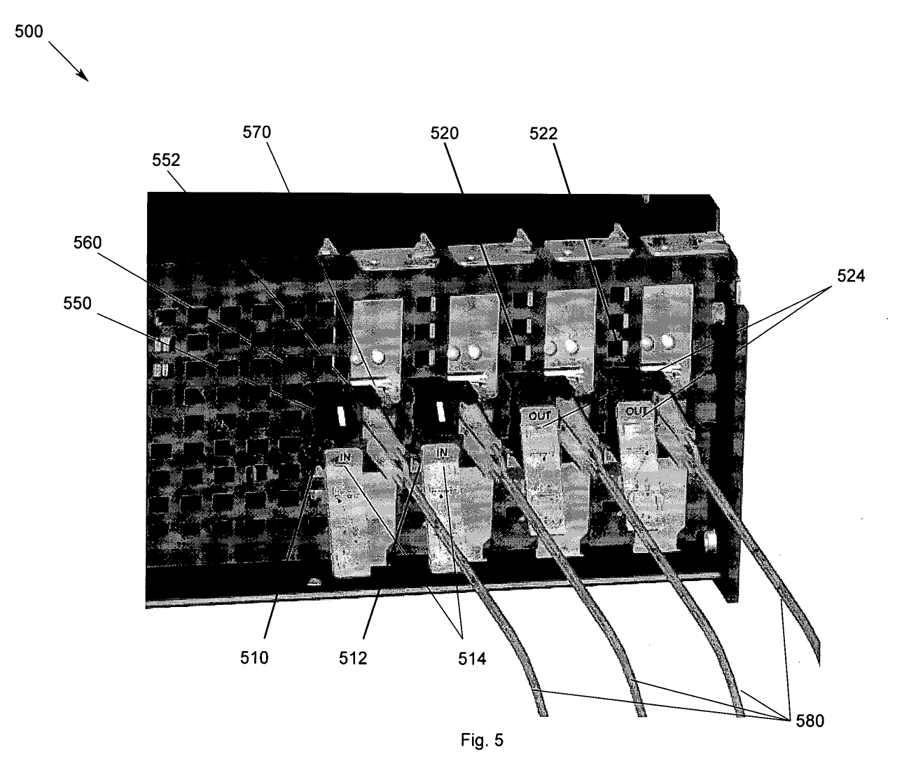

FIG. 4 illustrates a connector assembly 400 according to an embodiment of the present invention. The connector assembly includes a first subassembly portion 410 that snaps in a chassis proximate to a fiber optic connector on the chassis. The first subassembly portion 410 of the connector assembly may be oriented in one of two positions depending on whether the signal is supposed to go into or come out of the equipment (see FIG. 5 for different orientations). A second subassembly portion 420 is shown to include two interfaces 422, 424 for snapping onto the connector of the fiber cable. The second subassembly portion 420 may also be oriented in two positions depending on whether the signal is supposed to go into or come out of the equipment. However, the orientation of the first and second subassembly portions must both be aligned in either the first or second orientation so that their features mate. This prevents cable that is meant for coupling to receive connections from being plugged into transmit connections and vice versa. A third subassembly portion 440 of the connector assembly includes a tab (not shown) that slides into the slot 426 of the second subassembly portion 420. The third subassembly portion 440 provides a place to put a label identifying the cables destination and source. The third subassembly portion 440 is oriented to provide easy visual inspection.

FIG. 5 illustrates a plurality of connector assemblies 500 coupled to a chassis according to an embodiment of the present invention. As can be seen in FIG. 5, the two connector assemblies 510, 512 on the left are configured in a first orientation to provide incoming signals to the chassis. The two connector assemblies 520, 522 on the right are configured in a second orientation to provide out-going signals from the chassis. Each of the four assemblies 510, 512, 520, 522 includes labels: out-going labels 524 and incoming labels 514. The connector assemblies 510, 512, 520, 522 each include a first subassembly portion 550 that snaps in a chassis 560 proximate to a fiber optic connector 570 on the chassis. The second subassembly portion 552 snaps onto the connector of fiber cables 580.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A connector assembly, comprising:
a first portion for coupling to a chassis proximate to a fiber optic connector on the chassis; and
second portion configured for coupling onto the connector of a fiber cable;
wherein the first portion and the second portion each include a first and second orientation for indicating an incoming and an outgoing signal respectively, the first and second portions being aligned in one of the first or second orientations depending on whether the cable is for coupling to a receive or transmit connection.

2. The connector assembly of claim 1 further comprising a third portion for sliding into the second portion and providing a label to identify the cables destination and source.

3. The connector assembly of claim 2, wherein the third portion is oriented to provide easy visual inspection for ascertaining whether the cable is from a transmitter or a receiver.

4. The connector assembly of claim 1, wherein the cable comprises two cables, the first and second portion configured for coupled to two cables.

5. A communication system, comprising:
a first transceiver including at least one transmitter and at least one receiver;
a second transceiver including at least one transmitter and at least one receiver;
a first fiber optic cable disposed between the first transceiver and the second transceiver for coupling the transmitter of the first transceiver to the receiver of the second transceiver;
a second fiber optic cable disposed between the first transceiver and the second transceiver for coupling the receiver of the first transceiver to the transmitter of the second transceiver; and
a connector assembly coupled to each end of the first and second fiber optic cable, the connector assembly comprising:
a first portion for coupling to a chassis for a transceiver proximate to a fiber optic connector on the chassis;
second portion configured for coupling onto the connector of a fiber cable;
wherein the first portion and the second portion each include a first and second orientation for indicating an incoming and an outgoing signal respectively, the first and second portions being aligned in one of the first or second orientations depending on whether the cable is for coupling to a receiver or transmitter.

6. The communication system of claim 5 further comprising a third portion for sliding into the second portion and providing a label to identify the cables destination and source.

7. The communication system of claim 6, wherein the third portion is oriented to provide easy visual inspection for ascertaining whether the cable is from a transmitter or a receiver.

8. The communication system of claim 5, wherein the cable comprises two cables, the first and second portion configured for coupled to two cables.

9. A connector assembly, comprising:
first means for coupling to a chassis proximate to a fiber optic connector on the chassis; and
second means for coupling onto the connector of a fiber cable;
wherein the first means and the second means each include a first and second orientation for indicating an incoming and an outgoing signal respectively, the first and second means being aligned in one of the first or second orientations depending on whether the cable is for coupling to a receive or transmit connection.

10. A communication system, comprising:
first means for communicating including at least one means for transmitting and one means for receiving;
second means for communicating including at least one means for transmitting and one means for receiving;
first means, disposed between the first means for communicating and the second means for communicating, for providing a communication conduit between the means for transmitting of the first means for communicating to the means for receiving of the second means for communicating;
second means, disposed between the first means for communicating and the second means for communicating, for providing a communication conduit between the means for receiving of the first means for communicating to the means for transmitting of the second means for communicating;
means, coupled to each end of the first and second means for providing a communication conduit, for providing a connection interface, the means for providing a connection interface comprising:
first means for coupling to a chassis proximate to a communications conduit connector on the chassis; and
second means for coupling onto the connector of means for providing a communication conduit;
wherein the first means for coupling to a chassis and the second means for coupling onto the connector each include a first and second orientation for indicating an incoming and an outgoing signal respectively, the first means for coupling to a chassis and the second means for coupling onto the connector being aligned in one of the first or second orientations depending on whether the means for providing communications conduit is for coupling to means for receiving or means for transmitting.

11. A method for providing connector keying and identification for unidirectional fiber cables, comprising:
providing a first connector subassembly for coupling to a chassis proximate to a fiber optic connector on the chassis, the first connector subassembly including a first and second orientation for indicating an incoming and an outgoing signal respectively;
providing a second connector subassembly configured for coupling onto the connector of a fiber cable, the second connector subassembly including a first and second orientation for indicating an incoming and an outgoing signal respectively; and
aligning the first connector subassembly and the second connector subassembly in one of the first or second orientations depending on whether the cable is for coupling to a receive or transmit connection.
